(19) United States
(12) Patent Application Publication
(10) Pub. No.: US 2024/0273872 A1
(43) Pub. Date: Aug. 15, 2024

(54) HYPERSPECTRAL DATA INTERPRETATION USING CO-REGISTERED DATASETS AND ARTIFICIAL INTELLIGENCE

(71) Applicant: COLORADO SCHOOL OF MINES, Golden, CO (US)

(72) Inventors: Katharina Pfaff, Golden, CO (US); Thomas Monecke, Golden, CO (US); Amit Rotem, Golden, CO (US); Luis Tenorio, Golden, CO (US); Alexander Vidal, Golden, CO (US)

(21) Appl. No.: 18/441,842

(22) Filed: Feb. 14, 2024

Related U.S. Application Data
(60) Provisional application No. 63/485,218, filed on Feb. 15, 2023.

(51) Int. Cl. G06V 10/77; G06V 10/82; G06V 20/10; G06V 20/69

(52) U.S. Cl. CPC G06V 10/7715; G06V 10/82; G06V 20/194; G06V 20/698

(57) ABSTRACT

An example method disclosed herein includes training a mask model to generate masks of drill core data, wherein the mask model is trained using first training data comprising at least infrared images of the drill core data and training a mineral prediction model to generate mineralogy maps corresponding to the drill core data, where the mineral prediction model is trained using second training data comprising at least masks of the drill core data. The method further includes generating, by the mask model, a mask corresponding to a sample using a hyperspectral image corresponding to the sample and generating, by the mineral prediction model, a mineralogy map corresponding to the sample based on the mask corresponding to the sample.

### CROSS-REFERENCE TO RELATED APPLICATIONS

This application claims the benefit of priority to U.S. Provisional Patent Application No. 63/485,218, filed Feb. 15, 2023, entitled “HYPERSPECTRAL DATA INTERPRETATION USING CO-REGISTERED DATASETS AND ARTIFICIAL INTELLIGENCE,” the disclosure of which is hereby incorporated by reference in its entirety for all purposes.

### BACKGROUND

In the mining industry, knowledge of the mineralogical makeup of ore and host rock units in important at many stages of a project's life cycle, ranging from early exploration to production and remediation. Hyperspectral imaging is often used in the mining industry, as it allows mineralogical analysis of large amounts of drill core in a short period of time, permitting operators to acquire mineralogical data in nearly real-time during exploration and resource definition. Hyperspectral imaging of drill core typically involves measuring the absorption of light in the visible to near-infrared (VNIR) and short-wave infrared (SWIR). The composition of each measured pixel in the core scan can then be determined by spectral matching and feature fitting algorithms as part of data post processing.

However, such methods present limitations. For example, spectra are often produced by spectral overlap of different minerals present in each pixel, and common minerals such as garnet, olivine, feldspar and quartz, as well as many oxide and sulfide minerals, lack well defined diagnostic VNIR-SWIR spectral features. Moreover, the spectrally dominant mineral in a measured pixel may not be the dominant mineral in the pixel.

### SUMMARY

An example method disclosed herein includes training a mask model to generate masks of drill core data, wherein the mask model is trained using first training data comprising at least infrared images of the drill core data and training a mineral prediction model to generate mineralogy maps corresponding to the drill core data, where the mineral prediction model is trained using second training data comprising at least masks of the drill core data. The method further includes generating, by the mask model, a mask corresponding to a sample using a hyperspectral image corresponding to the sample and generating, by the mineral prediction model, a mineralogy map corresponding to the sample based on the mask corresponding to the sample.

Example non-transitory computer readable media disclosed herein are encoded with instructions which, when executed by one or more processors, cause the one or more processors to train a mask model to generate masks of drill core data, where the mask model is trained using first training data including at least infrared images of the drill core data and train a mineral prediction model to generate mineralogy maps corresponding to the drill core data, where the mineral prediction model is trained using second training data including at least the masks of the drill core data. The instructions further cause the one or more processors to generate, using the mask model, a mask corresponding to a sample using a hyperspectral image corresponding to the sample and generate, using the mineral prediction model, a mineralogy map corresponding to the sample based on the mask corresponding to the sample.

An example method disclosed herein includes processing hyperspectral data, generating first training data including the processed hyperspectral data and a plurality of masks corresponding to drill cores, and training a mask model to generate masks of drill core data using the first training data. The method further includes training a mineral prediction model to generate mineralogy maps corresponding to drill core data using the second training data, and generating a mineralogy map corresponding to a sample using the mask model and the mineral prediction model.

Additional embodiments and features are set forth in part in the description that follows, and will become apparent to those skilled in the art upon examination of the specification and may be learned by the practice of the disclosed subject matter. A further understanding of the nature and advantages of the present disclosure may be realized by reference to the remaining portions of the specification and the drawings, which form a part of this disclosure. One of skill in the art will understand that each of the various aspects and features of the disclosure may advantageously be used separately in some instances, or in combination with other aspects and features of the disclosure in other instances.

### BRIEF DESCRIPTION OF THE DRAWINGS

The description will be more fully understood with reference to the following figures in which components are not drawn to scale, which are presented as various examples of the present disclosure and should not be construed as a complete recitation of the scope of the disclosure, characterized in that:

FIG. 1 illustrates an example mineralogical data interpretation system and various components in communication with the mineralogical data interpretation system, in accordance with various examples described herein.

FIG. 2 illustrates an example block diagram of a mineralogical data interpretation system, in accordance with various examples described herein.

FIG. 3 illustrates an example method of training and utilizing a mask model and a mineral prediction model, in accordance with various examples described herein.

FIG. 4 illustrates an example method of training a mask model, in accordance with various examples described herein.

FIG. 5 illustrates an example method of training a mineral prediction model, in accordance with various examples described herein.

FIG. 6 illustrates a schematic diagram of an example computer system for implementing various embodiments in the examples described herein.

### DETAILED DESCRIPTION

Understanding the mineralogy and geochemistry of the subsurface is key when assessing and exploring for mineral deposits. To achieve this goal, rapid acquisition and accurate interpretation of drill core data are essential. Hyperspectral shortwave infrared imaging is a rapid and non-invasive analytical method widely used in the minerals industry to map minerals with diagnostic features in core samples. The system and methods disclosed herein provide a fast and accurate way to interpret hyperspectral shortwave infrared data on core to decipher major felsic rock forming minerals using supervised machine learning techniques for masking and extracting mineralogical and textural information. Such systems and methods utilize a co-registered training dataset that integrates hyperspectral data with quantitative XRF or scanning electron microscopy data instead of spectrum matching using a spectral library. Such systems and methods overcome previous limitations in hyperspectral data interpretation for the full mineralogy caused by the need to identify spectral features of minerals.

In the mining industry, knowledge of the mineralogical makeup of ore and host rock units is critical at many stages of a project's life cycle, ranging from early exploration to production and remediation. Hyperspectral core scanning is a rapid and non-invasive analytical method for mineral mapping of minerals with diagnostic features, whereas scanning electron microscopy-based automated mineralogy can provide high-resolution mineralogical maps showing the mineral modal abundance of predominant minerals of select subsamples. The combination of rapid hyperspectral core scanning with quantitative mineralogical data derived from SEM-based automated mineralogy allows for quantitative characterization of the mineralogy of a whole drill core by upscaling SEM-based automated mineralogy information rather than mapping out spectrally dominant minerals. A user-friendly software package can produce mineralogy maps of the drill core that can be further evaluated to deduce mineral abundance data (modal mineralogy), textural information and mineral association data. Such software can be used for a large number of drill cores to improve our understanding of ore zonation, related alteration assemblages, and the occurrence, mineralogy and spatial distribution of minerals in the subsurface. In addition to ore deposit studies, the research has implications to the characterization of waste rock piles and tailings and can be used in the interpretation of drill core from energy producers such as oil, gas, and geothermal.

Mineralogical data interpretation systems described herein may be used without requiring the minerals to have VNIR-SWIR diagnostic absorption features to be identified, nor does it require the use of spectral libraries, which may or may not be appropriate to identify minerals occurring at a given study site. Instead, the mineralogical data interpretation systems, and methods utilized by the mineralogical data interpretation systems learn identifying features from data. The use of an automated approach based on learning from the available data helps reduce the subjectivity in analysis and helps to avoid mineral identification based solely on spectral predominance. For example, supervised learning may be used to automate processes that usually rely on expert knowledge, such as defining masks for core measured in boxes and feature identification in spectra. Expert knowledge may further be incorporated, in some examples, in training neural networks within the mineralogical data interpretation system.

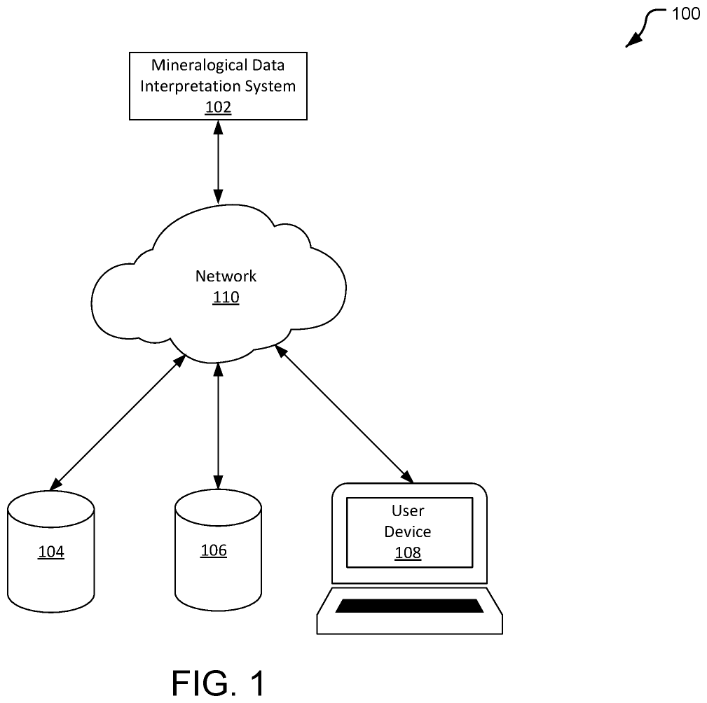

FIG. 1 illustrates an environment 100 including a mineralogical data interpretation system 102 and various components in communication with the mineralogical data interpretation system 102. For example, the mineralogical data interpretation system 102 may be accessible by user device 108 via a network 110. The mineralogical data interpretation system 102 may further utilize data from, or provide data to, various data storage locations 104, 106, which may also be accessible via the network 110.

In various examples, the mineralogical data interpretation system 102 may be generally implemented by a computing device or combinations of computing resources. In various examples, the mineralogical data interpretation system 102 may be implemented by one or more servers, cloud computing resources, and/or other computing devices. The mineralogical data interpretation system 102 may, for example, utilize various processing resources to receive hyperspectral data for samples, generate masks for the samples, and/or generate mineralogical predictions for the samples. The mineralogical data interpretation system 102 may further include memory and/or storage locations to store program instructions for execution by the processor and various data utilized by the mineralogical data interpretation system 102.

The mineralogical data interpretation system 102 may communicate with, obtain data from, and/or store results at various data stores 104, 106. In various examples, data stores 104, 106 may be accessible by the mineralogical data interpretation system 102 via the network 110. In some examples, the data stores 104, 106 may be local to the mineralogical data interpretation system 102. In some examples, the data stores 104, 106 may be implemented using cloud or other types of storage remote from the mineralogical data interpretation system 102.

User device 108 may be used to access and/or interact with the mineralogical data interpretation system 102. For example, a user device 108 and/or additional user devices may supply data (e.g., hyperspectral data, SEM data, manually created masks, and the like) to the mineralogical data interpretation system 102 for analysis and/or training the models of the mineralogical data interpretation system 102. The user device 108 and/or additional user devices may further receive mineralogical analysis and/or other information from the mineralogical data interpretation system 102. In various implementations, the user device 108 may be implemented using any number of computing devices including, but not limited to, a computer, a laptop, tablet, mobile phone, smart phone, wearable device (e.g., AR/VR headset, smart watch, smart glasses, or the like), measurement equipment, or other smart devices. Generally, the user device 108 may include one or more processors, such as a central processing unit (CPU) and/or graphics processing unit (GPU). The user device 108 may generally perform operations by executing executable instructions (e.g., software) using the processor(s).

The network 110 may be implemented using one or more of various systems and protocols for communications between computing devices. In various embodiments, the network 110 or various portions of the network 110 may be implemented using the Internet, a local area network (LAN), a wide area network (WAN), and/or other networks. In addition to traditional data networking protocols, in some embodiments, data may be communicated according to protocols and/or standards including near field communication (NFC), Bluetooth, cellular connections, and the like.

Components of the mineralogical data interpretation system 102 and in communication with the mineralogical data interpretation system 102 shown in FIG. 1 are exemplary and may vary in some embodiments. For example, in some embodiments, the mineralogical data interpretation system 102 may be distributed across multiple computing elements, such that components of the mineralogical data interpretation system 102 communicate with one another through the network 110. Further, in some embodiments, computing resources dedicated to the mineralogical data interpretation system 102 may vary over time based on various factors such as usage of the mineralogical data interpretation system 102.

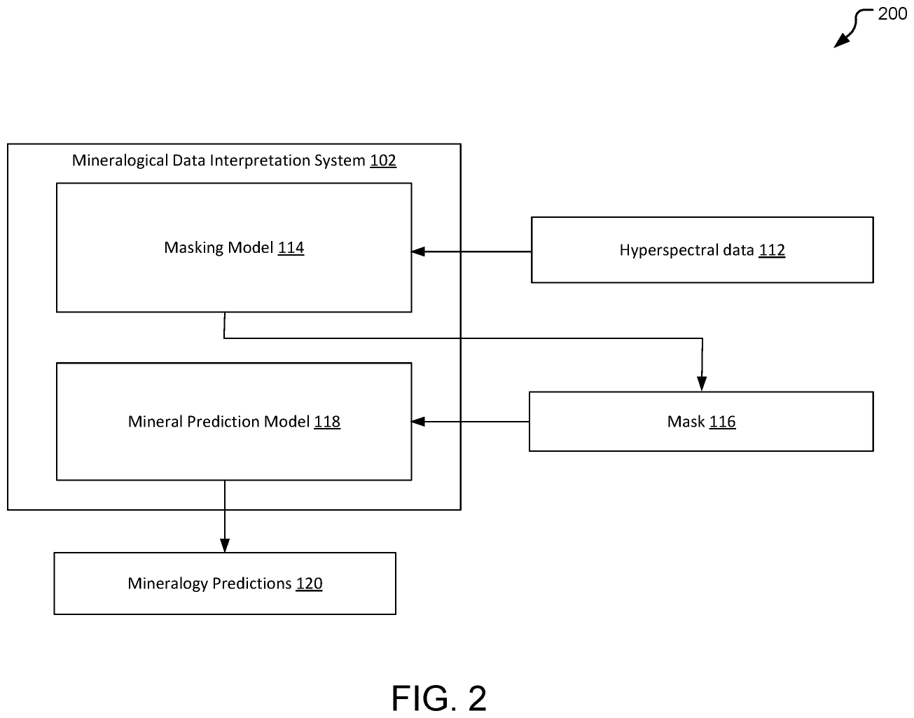

FIG. 2 illustrates an example block diagram of a mineralogical data interpretation system 102. The mineralogical data interpretation system 102 shown in FIG. 2 may generally include a trained masking model 114 and a trained mineral prediction model 118. Such models may be trained using methods discussed herein. Generally, the masking model 114 may receive hyperspectral data 112 related to a sample and may generate a mask 116 corresponding to the sample based on such hyperspectral data 112. The mineral prediction model 118 may then utilize the mask 116 to generate mineralogy predictions 120 for the sample. In various examples, such mineralogy predictions 120 may be identification of minerals (e.g., mineral assignments) for each pixel in the hyperspectral data 112. Such identifications may be generated by identifying, by the mineral prediction model 118, the most abundant mineral occurring the in the pixel.

In various examples, hyperspectral data 112 may include hyperspectral imaging data, such as VNIR and SWIR image data.

In various examples, the masking model 114 may be a convolutional neural network (CNN) trained to generate masks based on hyperspectral data 112. For example, the masking model 114 may be generated based on a CNN image segmentation model, such as a simplified version of a SegNet model. The SegNet model is general a convolutional encoder-decoder model with a classification layer, where the encoder includes convolution layers that are down-sampled three times by a factor of two down to a final size of 34 by 22 pixels. The decoder includes transpose convolution layers and is up-sampled every three layers until the original image size is restored. Such structure is able to capture low-resolution details in the image, while loss of high-resolution detail may be reduced using skip-connections that match encoder to decoder layers of the same size. Such skip-connections transfer information between layers by storing the indices of pixels preserved during the downsampling stages, and fills the upsampled layers at the same indices, while filling the rest by bilinear interpolation to preserve the structure of the information in the image. In some examples, the masking model 114 may be generated based on or may be a simplified version of the SegNet model, which passes the output of a layer before downsampling to the corresponding layer after upsampling and adds the two outputs together. Using skip-connections, the model is able to interpret images on scales ranging from single-pixel to larger clusters of pixels that encode global information.

In various examples, the mask model 114 may be further trained to identify and/or remove finer details, such as broken material. For example, the mask model 114 may include a second neural network for removal of these smaller details from the mask. In some applications, the second neural network may be used to locate broken material in core boxes, which may be useful as the broken material general does not properly represent the length of drill core and may result in incorrect depth registration. Accordingly, these areas may be masked using the second neural network.

The masking model 114 may generate masks 116 corresponding to the hyperspectral data 112. Masks are generally used to exclude data pixels from core boxes (e.g., from core samples) that are not useful to the mineral prediction model, such as the box frame, wooden blocks indicating the drill depth, and/or broken material that is too fine-grained to yield good reflectance or that prohibits correct depth registration. Accordingly, preprocessing using masks generally improves the overall quality of the data used to train the network and obtain the mineral predictions. For example, masks 116 obtained using the mask model 114 may be used for mineral classification in combination with the mineral prediction model 118.

A mineral prediction model 118 may receive a mask 116 corresponding to the hyperspectral data 112 to generate mineralogy predictions 120 for the hyperspectral data 112.

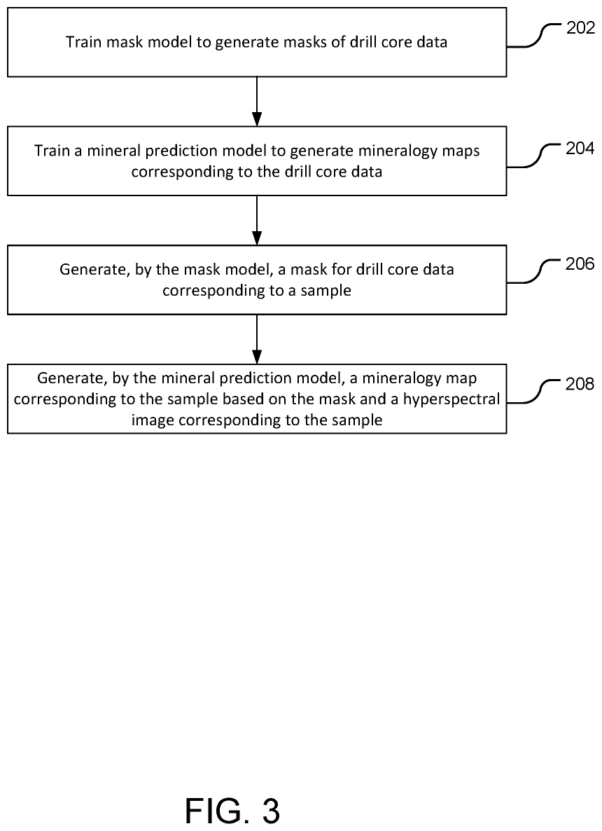

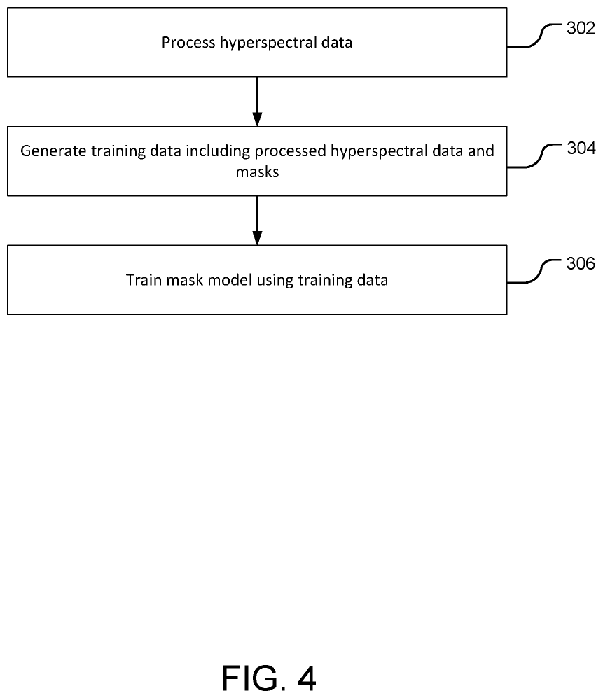

FIG. 3 illustrates an example method 300 of training and utilizing a mask model and a mineral prediction model, in accordance with various examples described herein. At block 202, a mask model may be trained to generate masks of drill core data. Generally, the mask model may be trained using the methods described with respect to FIG. 4.

With reference to FIG. 4, at block 302, training data for the mask model is preprocessed. For example, short wave infrared (SWIR) images may be compressed for training the mask model using compression methods such as principal component analysis (PCA). For example, training a CNN with un-compressed SWIR images may be computationally expensive, and CNN algorithms generated with such images may be inefficient in use of both computational an memory resources. Accordingly, preprocessing (e.g., through dimensional reduction) may be used to save computational resources both at the training step and for the ultimate CNN generated through the training.

At block 304, training data is generated, where the training data includes hyperspectral data and masks. In various examples, the hyperspectral data may be various infrared images, such as SWIR images, which may be preprocessed using the methods described with respect to block 302. The training data further includes masks, which may, in various examples, be hand drawn masks drawn by experts, enabling the mask model 114 to learn masking techniques similar to masking conducted by such experts.

The mask model 114 is trained using training data at block 306. The mask model 114 is generally trained using supervised machine learning techniques based on CNNs. For example, supervised learning may be performed with a particular CNN image segmentation model that is a simplified version of the CNN SegNet architecture. The mask model 114 may be trained using a stochastic gradient based method, such as the ADAM method. In some examples, such methods may be used for 100 epochs with batch-size of five images.

In various examples, images output from the mask model 114 in the training phase may be post-processed using wavelet spatial smoothing with a second order Daubechies wavelet. Such post-processing may produce masks that have continuous segments, and may also remove artifacts that have been introduced by the CNN model. A second order wavelet may provide an acceptable combination of artifact removal, continuity, and mask quality.

In some examples, the mask model 114 may be further trained to identify and/or remove finer details in images. In such examples, the mask model 114 may include a second machine learning model that is trained to take the masked output of the CNN and identify pixels of interest excluding broken material. The second machine learning model may be a neural network including one fully connected layer and a classification layer. Training data for the second machine learning model may be generated based on randomly selected image, with k-means clustering used to identify pixels of interest by grouping pixels into clusters (e.g., three clusters). The clusters containing pixels of interest may then be identified (e.g., manually), and the data labeled to use to train the second machine learning model.

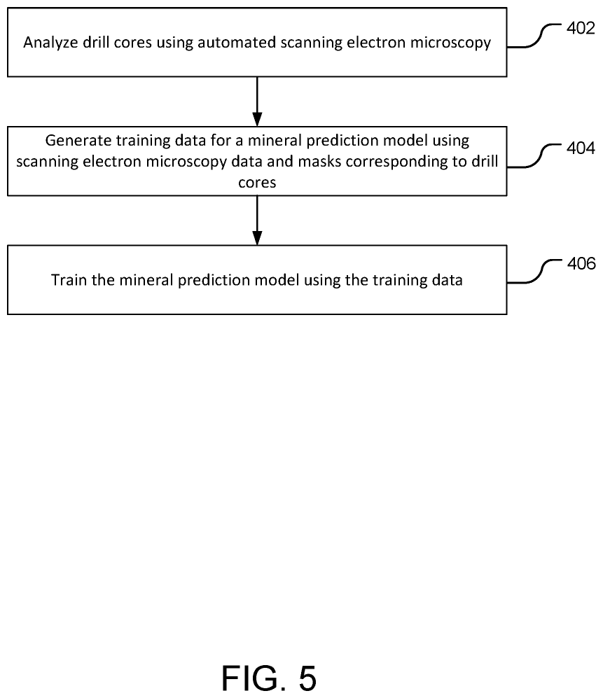

Returning to FIG. 3, at block 204, the mineral prediction model is trained to generate mineralogy maps corresponding to the drill core data. Generally, the mineral prediction model may be trained using the methods described in FIG. 5.

FIG. 5 illustrates an example method of training a mineral prediction model for use in a mineralogical data interpretation system 102. At block 402, drill cores are analyzed using automated scanning electron microscopy (SEM). For example, thin sections may be obtained from the samples used to train the mask model 114 (e.g., the samples from which hyperspectral data is obtained). The thin sections may be scanned using SEM. For example, the thin sections may be scanned and energy-dispersive X-ray (EDX) spectrometry and backscattered electron (BSE) imaging may be conducted. The EDX spectra may then be compared to spectra held in a look-up table, thus allowing a mineral assignment to be made at each acquisition point. Such analysis may produce a compositional mineral map, which may be used to train the mineral prediction model 118.

Training data for the mineral prediction model 118 is generated at block 404, using the SEM data and masks. In some examples, the data may be preprocessed to account for various factors. For example, the thin section and core box data may vary in significant ways. For example, the core box images may be larger and may represent materials at widely varying scale and texture, in comparison with thin section data. In some examples, such preprocessing may include using a stochastic autoencoder model (SAE) to transform data to a latent space where the two data sets have comparable distributions. For example, a SAE used for preprocessing may be a variation of a traditional variational autoencoder. In some examples, such preprocessing may include linearly interpolating the core box data to a chosen number of wavelengths. The pixels in each dataset may then be centered and scaled to zero sample mean and unit variance for each wavelength. The two datasets may be combined to train a linear SAE that learned a common distribution for the two data sources.

At block 406, the mineral prediction model 118 is trained using the training data. The mineral prediction model 118 may generally, when trained, use a latent variable î of a pixel to predict a mineralogy label for such pixel. The mineral prediction model 118 may be a dense neural network with two hidden layers. For example, the first layer may have 100 neurons and the second layer may have 50 neurons. Both layers may use the ReLU activation function. During training or generation of the mineral prediction model 118, the weights of each layer may be obtained using penalized least squares with the squared-norm of the coefficients as penalty. The mineral prediction model 118 may be trained using thin-section images (with the pixels transformed to corresponding latent variables) and corresponding modal SEM labels. The images may be randomly grouped into a training set and a testing set, where the training set is used to train the mineral prediction model 118 with corresponding masks and the testing set is used to validate or test the mineral prediction model 118 with corresponding masks. The optimal regularization parameter for the penalized least squares may be determined using an exhaustive search and choosing the parameter that produced the best accuracy on the test set.

Returning to FIG. 3, the masking model 114 generates a mask for drill core data corresponding to a sample at block 206. For example, the trained masking model 114 may receive hyperspectral data for a sample (e.g., SWIR images) and may generate a mask for the sample. At block 208, the mineral prediction model 118 generates a mineralogy map corresponding to the sample based on the mask and a hyperspectral image corresponding to the sample. The hyperspectral image may be the SWIR image provided to the masking model 114 and the mask may be the mask generated by the trained masking model 114 at block 206. The generated mineralogy map may generally predict the mineralogy (e.g., predicted modal mineral abundance) for core-box images of the sample. The generated mineralogy map may include an identified mineral for each pixel of the core box image and/or the mask generated by the masking model 114. Such a mineralogy map may further be utilized by geologist or others as a prediction of the mineral modal abundance in textural domains.

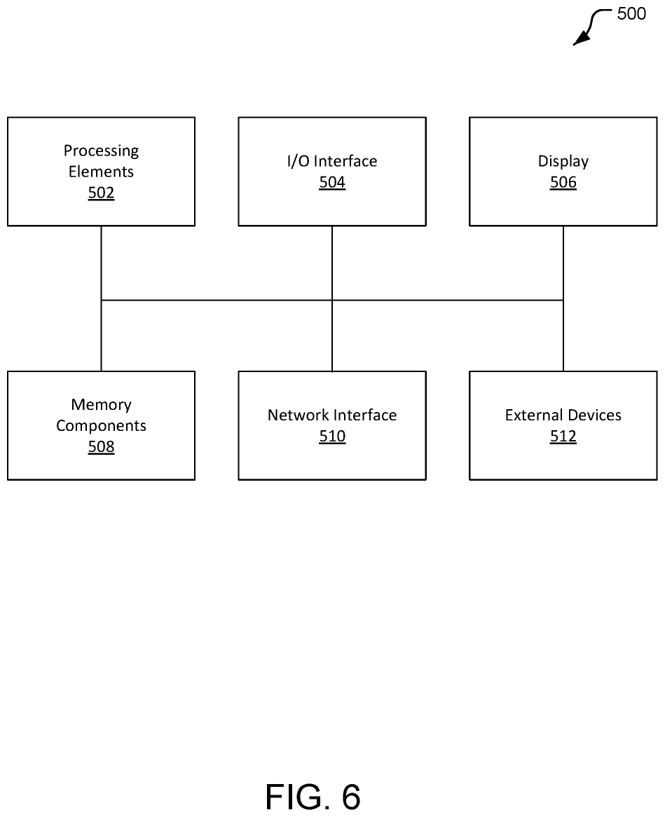

FIG. 6 is a schematic diagram of an example computer system 500 for implementing various embodiments in the examples described herein. A computer system 500 may be used to implement or may be integrated into various components of the mineralogical data interpretation system 102. For example, the masking model 112 and/or the mineral prediction model may include one or more of the components of the computer system 500 shown in FIG. 7. The computer system 500 is used to implement or execute one or more of the components or operations disclosed in FIGS. 1-5. In FIG. 6, the computer system 500 may include one or more processing elements 502, an input/output interface 504, a display 506, one or more memory components 508, a network interface 510, and one or more external devices 512. Each of the various components may be in communication with one another through one or more buses, communication networks, such as wired or wireless networks.

The processing element 502 may be any type of electronic device capable of processing, receiving, and/or transmitting instructions. For example, the processing element 502 may be a central processing unit, microprocessor, processor, or microcontroller. Additionally, it should be noted that some components of the computer 500 may be controlled by a first processor and other components may be controlled by a second processor, where the first and second processors may or may not be in communication with each other.

The memory components 508 are used by the computer 500 to store instructions for the processing element 502, as well as store data, such as order and flight data 124 (FIG. 2) and the like. The memory components 508 may be, for example, magneto-optical storage, read-only memory, random access memory, erasable programmable memory, flash memory, or a combination of one or more types of memory components.

The display 506 provides visual feedback to a user, such as a display of the user device 108 (FIG. 1). Optionally, the display 506 may act as an input element to enable a user to control, manipulate, and calibrate various components of the user device 108. The display 506 may be a liquid crystal display, plasma display, organic light-emitting diode display, and/or other suitable display. In embodiments where the display 506 is used as an input, the display may include one or more touch or input sensors, such as capacitive touch sensors, a resistive grid, or the like.

The I/O interface 504 allows a user to enter data into the computer 500, as well as provides an input/output for the computer 500 to communicate with other devices or services (e.g., mineralogical data interpretation system 102 and/or other components in FIG. 1). The I/O interface 504 can include one or more input buttons, touch pads, and so on.

The network interface 510 provides communication to and from the computer 500 to other devices. For example, the network interface 510 allows the user device 108 to communicate with the mineralogical data interpretation system 102 through a communication network. The network interface 510 includes one or more communication protocols, such as, but not limited to WiFi, Ethernet, Bluetooth, and so on. The network interface 510 may also include one or more hardwired components, such as a Universal Serial Bus (USB) cable, or the like. The configuration of the network interface 510 depends on the types of communication desired and may be modified to communicate via Wifi, Bluetooth, and so on.

The external devices 512 are one or more devices that can be used to provide various inputs to the computing device 500, e.g., mouse, microphone, keyboard, trackpad, or the like. The external devices 512 may be local or remote and may vary as desired. In some examples, the external devices 512 may also include one or more additional sensors.

The mineralogical data interpretation system 102 described herein may utilize hyperspectral data, such as SWIR data to identify minerals located at various sites using machine learning models trained using hyperspectral data and complementing SEM based quantitative mineralogical data. Hyperspectral SWIR data are widely used during various stages of a mine's lifecycle to complement traditional core logging. Hyperspectral core scanning is a rapid and non-invasive analytical method for mineral mapping of minerals with diagnostic features, whereas SEM-based quantitative automated mineralogy can provide high-resolution mineralogical maps showing the mineral modal abundance of predominant minerals of select subsamples. The combination of rapid hyperspectral core scanning with quantitative mineralogical data derived from SEM-based automated mineralogy provided by the mineralogical data interpretation system 102 allows for quantitative characterization of the mineralogy of a drill core by upscaling SEM-based quantitative automated mineralogy information rather than mapping out spectrally dominant minerals. The mineralogy maps generated by the mineralogical data interpretation system 102 may be, in various examples, used to deduce mineral abundance data, textural information, and mineral association data.

The mineralogical data interpretation system 102 described herein has the potential to enhance traditional techniques used in hyperspectral data interpretation of geological materials. For example, machine learning may be used to interpret hyperspectral data of a drill core using a training set of automated mineralogy and hyperspectral data collected on a small number of samples from the core to be analyzed. The mineralogical data system 102 overcomes limitations in previous methods of hyperspectral data interpretation that are caused by the need to identify spectral features of minerals. Further, the mineralogical data interpretation system 102 may be used to automate routine pre- and post-processing tasks such as masking.

A particular implementation of the mineralogical data interpretation system 102 is described in Appendix A to the Specification, entitled “Interpretation of Hyperspectral Shortwave Infrared Core Scanning Using SEM-Automated Mineralogy: A Machine Learning Approach.”

The foregoing description has a broad application. For example, while examples disclosed herein may focus on central communication system, it should be appreciated that the concepts disclosed herein may equally apply to other systems, such as a distributed, central or decentralized system, or a cloud system. For example, the mineralogical data interpretation system 102 and/or other components in the distribution system (e.g., distribution center inventory and computing systems) may reside on a server in a client/server system, on a user mobile device, or on any device on the network and operate in a decentralized manner.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A method comprising:
training a mask model to generate masks of drill core data, wherein the mask model is trained using first training data comprising at least infrared images of the drill core data;
training a mineral prediction model to generate mineralogy maps corresponding to the drill core data, wherein the mineral prediction model is trained using second training data comprising at least the masks of the drill core data;
generating, by the mask model, a mask corresponding to a sample using a hyperspectral image corresponding to the sample; and
generating, by the mineral prediction model, a mineralogy map corresponding to the sample based on the mask corresponding to the sample.

2. The method of claim 1, wherein the mineralogy map comprises, for each pixel in the mask, an assignment of a mineral, wherein the mineral is identified by the mineral prediction model as the most abundant mineral occurring in the pixel.

3. The method of claim 1, further comprising:
processing hyperspectral data; and
generating the first training data using the processed hyperspectral data.

4. The method of claim 1, further comprising generating the second training data using scanning electron microscopy data and the masks of the drill core data.

5. The method of claim 1, wherein the mask model is a convolutional neural network.

6. The method of claim 1, wherein the mineral prediction model is a dense neural network.

7. One or more non-transitory computer readable media encoded with instructions which, when executed by one or more processors, cause the one or more processors to:
train a mask model to generate masks of drill core data, wherein the mask model is trained using first training data comprising at least infrared images of the drill core data;
train a mineral prediction model to generate mineralogy maps corresponding to the drill core data, wherein the mineral prediction model is trained using second training data comprising at least the masks of the drill core data;
generate, using the mask model, a mask corresponding to a sample using a hyperspectral image corresponding to the sample; and
generate, using the mineral prediction model, a mineralogy map corresponding to the sample based on the mask corresponding to the sample.

8. The one or more non-transitory computer readable media of claim 7, wherein the mineralogy map comprises, for each pixel in the mask, an assignment of a mineral, wherein the mineral is identified by the mineral prediction model as the most abundant mineral occurring in the pixel.

9. The one or more non-transitory computer readable media of claim 7, wherein the instructions further cause the one or more processors to:
process hyperspectral data; and
generate the first training data using the processed hyperspectral data.

10. The one or more non-transitory computer readable media of claim 7, wherein the instructions further cause the one or more processors to generate the second training data using scanning electron microscopy and the masks of the drill core data.

11. The one or more non-transitory computer readable media of claim 7, wherein the mask model is a convolutional neural network.

12. The one or more non-transitory computer readable media of claim 11, wherein the mask model comprises a second neural network trained to remove fine details from the masks generated by the mask model.

13. The one or more non-transitory computer readable media of claim 7, wherein the mineral prediction model is a dense neural network.

14. A method comprising:
processing hyperspectral data;
generating first training data including the processed hyperspectral data and a plurality of masks corresponding to drill cores;
training a mask model to generate masks of drill core data using the first training data;
generating second training data using scanning electron microscopy data and the plurality of masks;
training a mineral prediction model to generate mineralogy maps corresponding to drill core data using the second training data; and
generating a mineralogy map corresponding to a sample using the mask model and the mineral prediction model.

15. The method of claim 14, wherein generating the mineralogy map comprises:
generating, by the mask model, a mask corresponding to the sample using a hyperspectral image corresponding to the sample; and
generating, by the mineral prediction model, the mineralogy map based on the mask corresponding to the sample.

16. The method of claim 14, wherein generating the second training data comprises preprocessing the scanning electron microscopy data and the second plurality of masks using a stochastic autoencoder model.

17. The method of claim 14, wherein the mask model is a convolutional neural network.

18. The method of claim 14, wherein the mineral prediction model is a dense neural network.

19. The method of claim 14, wherein the mineralogy map comprises, for each pixel in the mask, an assignment of a mineral, wherein the mineral is identified by the mineral prediction model as the most abundant mineral occurring in the pixel.

20. The method of claim 14, wherein the mask model is further trained to remove fine details from the masks generated by the mask model.
